(19) United States
(12) Patent Application Publication
(10) Pub. No.: US 2011/0262047 A1
(43) Pub. Date: Oct. 27, 2011

(54) DOT PATTERN ENCODING STRUCTURE, ITS DECODING METHOD AND ELECTRONIC DEVICE

(76) Inventor: Shou-Te WEI, Hsinchu City (TW)

(21) Appl. No.: 13/092,481

(22) Filed: Apr. 22, 2011

(30) Foreign Application Priority Data
Apr. 27, 2010 (TW) 99113252

(51) Int. Cl. G06K 9/36

(52) U.S. Cl. 382/232

(57) ABSTRACT

A dot pattern encoding structure includes at least a pattern unit including a unit recognition portion containing a plurality of first dot patterns part or all of which are co-linear and equally distanced, and a plurality of first and second virtual grid lines passing through the first dot patterns; and a content portion containing a plurality of encoding areas and a starting position each formed by crossing of two of the virtual grid lines, wherein each encoding area contains a second dot pattern disposed in one of four quadrants, the first virtual grid line or the second virtual grid line, and a pattern configuration at the starting position is different from that of any encoding area. A decoding method for the dot pattern encoding structure and an electronic device for decoding the dot pattern encoding structure are also herein provided.

### BACKGROUND OF THE INVENTION

1. Field of the Invention

The present invention is in the field of pattern recognition technology, and more particularly concerns a dot pattern encoding structure, its decoding method and electronic device.

2. Description of the Prior Art

Dot pattern encoding, an encoding technique through which specific information is implicitly contained in a pattern laid out according to specific rules, has been widely applied to various commercial products, such as interactive toys or teaching materials for children. In these toys or teaching materials, there are clearly and obviously printed major information as well as less visually obvious dot patterns printed behind the major information like a background. When a user reads the major information and scans the background dot patterns with an optical reading device to a computer or any other device at the same time, the dot patterns may be decoded and the corresponding information may be output. However, some of the designs for encoding structure sacrifice appearance for encoding convenience, and are therefore less pleasing to the user's eyes. Besides, improving the encoding technique to increase the recognition rate is also highly concerned by vendors.

### SUMMARY OF THE INVENTION

The present invention is directed to a dot pattern encoding structure, its decoding method and electronic device. The encoding structure is not only more visually pleasing but also has more accurate decoding effects.

According to an embodiment, a dot pattern encoding structure includes at least a pattern unit. The pattern unit includes a unit recognition portion and a content portion. The unit recognition portion contains a plurality of first dot patterns part or all of which are co-linear and equally distanced; and a plurality of first virtual grid lines and a plurality of second virtual grid lines passing through the first dot patterns, wherein the first virtual grid lines and the second virtual grid lines cross with each other and form a plurality of virtual intersecting points. The content portion contains a plurality of encoding areas and a starting position formed by crossing of the first virtual grid lines and second virtual grid lines, wherein each of the encoding areas contains a second dot pattern disposed in one of four quadrants, or on the first virtual grid line or the second virtual grid line, and a pattern configuration at the starting position is different from that in any of the encoding areas.

According to another embodiment, a decoding method for a dot pattern encoding structure includes the following steps. An image containing at least a dot pattern encoding structure is obtained. The dot pattern encoding structure includes at least a pattern unit consisting of a single pattern unit or a plurality of pattern units. The pattern unit includes a unit recognition portion and a content portion. The unit recognition portion contains a plurality of first dot patterns part or all of which are co-linear and equally distanced; and a plurality of first virtual grid lines and a plurality of second virtual grid lines passing through the first dot patterns, wherein the first virtual grid lines and the second virtual grid lines cross with each other and form a plurality of virtual intersecting points. The content portion contains a plurality of encoding areas and a starting position formed by crossing of the first virtual grid lines and second virtual grid lines, wherein each of the encoding areas contains a second dot pattern disposed in one of four quadrants, or on the first virtual grid line or the second virtual grid line, and a pattern configuration at the starting position is different from that in any of the encoding areas. Then, the unit recognition portion in the image is determined. Next, the starting position in the image is determined. Then, relative positions of the second dot patterns in the encoding areas in the content portion are determined for decoding.

According to another embodiment, an electronic device for decoding a dot pattern decoding structure includes an image sensing unit and a decoding processing unit. The image sensing unit is for obtaining an image including the dot pattern encoding structure, wherein the dot pattern encoding structure includes at least a pattern unit. The pattern unit includes a unit recognition portion and a content portion. The unit recognition portion contains a plurality of first dot patterns part or all of which are co-linear and equally distanced; and a plurality of first virtual grid lines and a plurality of second virtual grid lines passing through the first dot patterns, wherein the first virtual grid lines and the second virtual grid lines cross with each other and form a plurality of virtual intersecting points. The content portion contains a plurality of encoding areas and a starting positions formed by crossing of the first virtual grid lines and second virtual grid lines, wherein each of the encoding areas contains a second dot pattern disposed in one of four quadrants, or on the first virtual grid line or the second virtual grid line, and a pattern configuration at the starting position is different from that in any of the encoding areas. The decoding processing unit is for determining the unit recognition portion, the starting position and relative positions of the second dot patterns in the encoding areas in the content portion for decoding.

The objective, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

FIG. 1A, FIG. 1B, FIG. 1C, FIG. 2, FIG. 3A, FIG. 3B, FIG. 4, FIG. 5, FIG. 6 and FIG. 7 are enlarged schematic diagrams illustrating dot pattern encoding structures according to embodiments of the present invention;

FIG. 8A, FIG. 8B, FIG. 8C and FIG. 8D are schematic diagrams illustrating a plurality of pattern units arranged in matrix according to embodiments of the present invention;

FIG. 9 is a flow chart of the decoding method for the dot pattern encoding structures according to an embodiment of the present invention;

FIG. 10A, FIG. 10B. and FIG. 10C are schematic structural diagrams illustrating the decoding method for the dot pattern encoding structure according to an embodiment of the present invention;

FIG. 11A and FIG. 11B are schematic structural diagrams illustrating the decoding method for the dot pattern encoding structure according to another embodiment of the present invention;

FIG. 12A and FIG. 12B are schematic structural diagrams illustrating the decoding method for the dot pattern encoding structure according yet another embodiment of the present invention; and

FIG. 13 is a block diagram illustrating the electronic device according to an embodiment of the present invention.

### DESCRIPTION OF THE PREFERRED EMBODIMENT

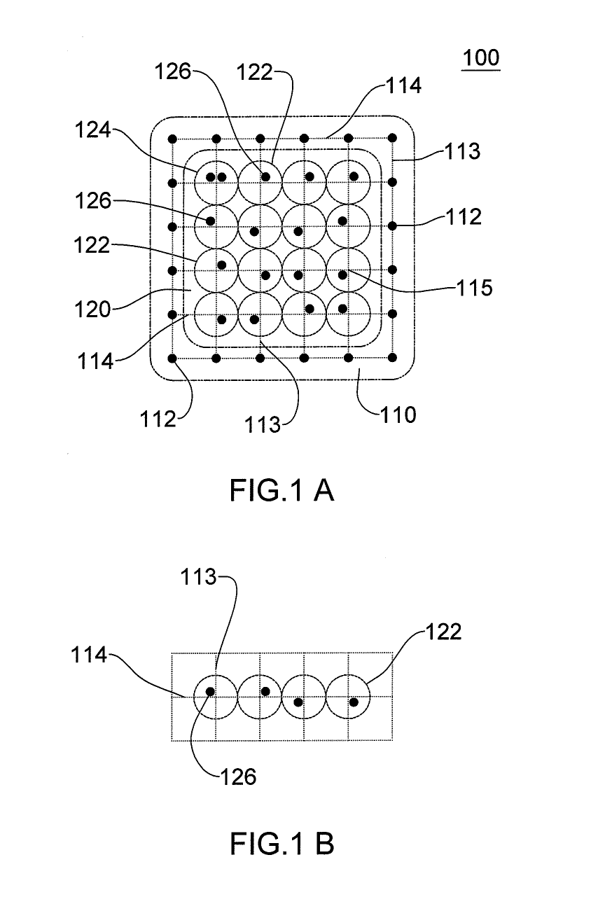

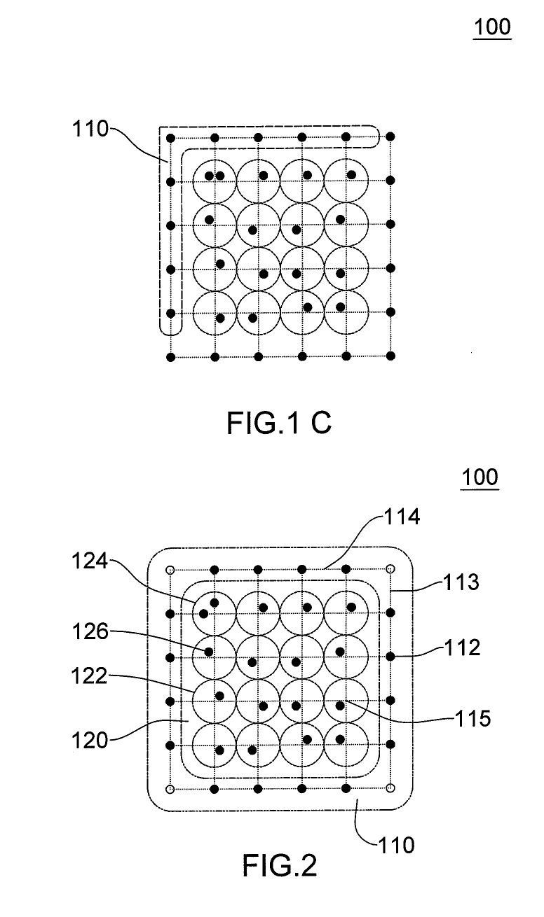

Referring to FIG. 1A, FIG. 1A is an enlarged schematic diagram illustrating the dot pattern encoding structure according to an embodiment. As shown in the figure, the dot pattern encoding structure includes at least a pattern unit 100, and one pattern unit 100 is illustrated to exemplify this embodiment. The pattern unit 100 includes a unit recognition portion 110 and a content portion 120. The unit recognition portion 110 is for a single pattern unit 100 to be recognized in the dot pattern encoding structure. It includes a plurality of first dot patterns 112 part or all of which are co-linear and equally distanced, and a plurality of first virtual grid lines passing through the first dot patterns 112, such as the virtual grid lines 113, and a plurality of second virtual grid lines passing through the first dot patterns 112, such as the virtual grid lines 114, wherein the virtual grid lines 113 and the virtual grid lines 114 cross each other and form a plurality of virtual intersecting points 115. It can be understood that the foregoing dot pattern encoding structure is adequately disposed on an object, and the aforementioned virtual grid lines 113, 114 and virtual intersecting points 115 are for aiding encoding or decoding, and are not visible to a user on the object.

Continuing the above description and referring still to FIG. 1A, the content portion 120 for storing information data has a plurality of encoding areas 122 and a starting position 124 formed by crossing the virtual grid lines 113 and virtual grid lines 114, wherein each of the encoding areas 122 has a second dot pattern 126 arranged in one of the four quadrants formed by the crossing first virtual grid line 113 and second virtual grid line 114, and on the virtual grid line 113 or the virtual grid line 114; and a pattern configuration in the starting position 124 is different from that in any of the encoding areas 122. As illustrated in FIG. 1B, the encoding area 122 may be divided by the virtual grid lines 113, 114 into four quadrants, and the second dot pattern 126 may be disposed in one of the four quadrants that correspond to different values. In the present embodiment, the unit recognition portion 110 is located on the periphery of the pattern unit 100, and the starting position 124 contains two second dot patterns 126. According to an embodiment, the unit recognition portion 110 may also have a configuration as illustrated in FIG. 1C.

According to another embodiment as shown in FIG. 2, in order to make the pattern unit 100 more visually pleasing, the virtual intersecting points 115 at the four corners of the pattern unit 100 may be left blank. Next, referring to FIG. 3A, according to yet another embodiment, the two second dot patterns 126 at the starting position 124 are respectively arranged on the virtual grid lines 113, 114. In this way, leaving the virtual intersecting point 115 adjacent to the two dot patterns 126 at the starting position 124 blank creates a better visual impression. The second dot patterns 126 on the virtual grid lines 113, 114 may be arranged into configurations show in FIG. 3B.

In the foregoing embodiments, the unit recognition portions 110 are all located on the periphery of the pattern units 100, and the starting positions 124 of the content portions 120 all contain two or more second patterns 126. However, it can be understood that as long as the pattern configuration at the starting position 124 is different from that in any of the encoding areas 122, the encoding direction of the contention portion 120 may be identified. Therefore, according to an embodiment as shown in FIG. 4, the starting position 124 of the content portion 120 in the pattern unit 100 may also be blank.

According to still another embodiment, a dot pattern encoding structure as shown in FIG. 5 is arranged such that a unit recognition portion 110 is located on its diagonal line. In this manner, the dot pattern encoding structure has more editable second dot patterns 126. As illustrated in FIG. 5, virtual grid lines 113 and virtual grid lines 114 passing through first dot patterns 112 cross with each other and form a plurality of encoding areas and a starting position 124. A content portion 120 is located on the left and right sides of the unit recognition portion 110. The pattern configuration at the starting position 124 is also different from that of any encoding area 122 so as to define the encoding direction.

Continuing the above description, an embodiment shown in FIG. 6 is different from the embodiment shown in FIG. 5 in that the second dot patterns 127 adjacent to the first dot patterns 112 are arranged on the virtual grid lines 113 or virtual grid lines 114. These second dot patterns 127 may be used for calibrating virtual coordinate plane formed by the plurality of virtual grid lines 113 and the plurality of virtual grid lines 114. Next, in yet another embodiment as shown in FIG. 7, the unit recognition portion 110 may also be disposed on an oblique line having an included angle with the diagonal line of the pattern unit 100.

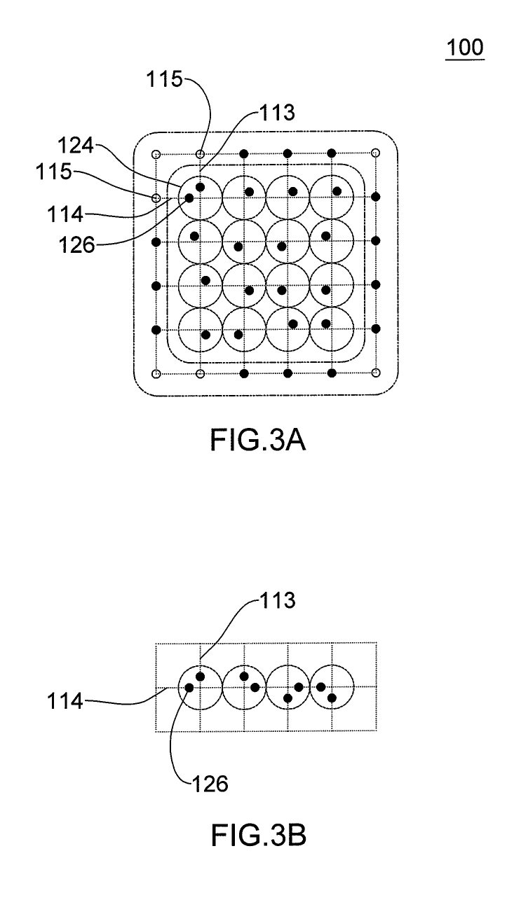

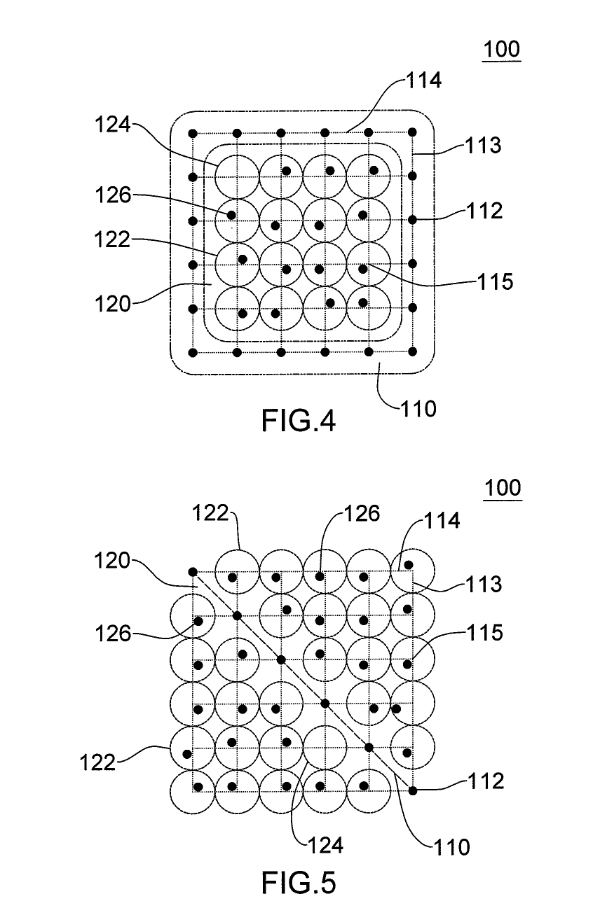

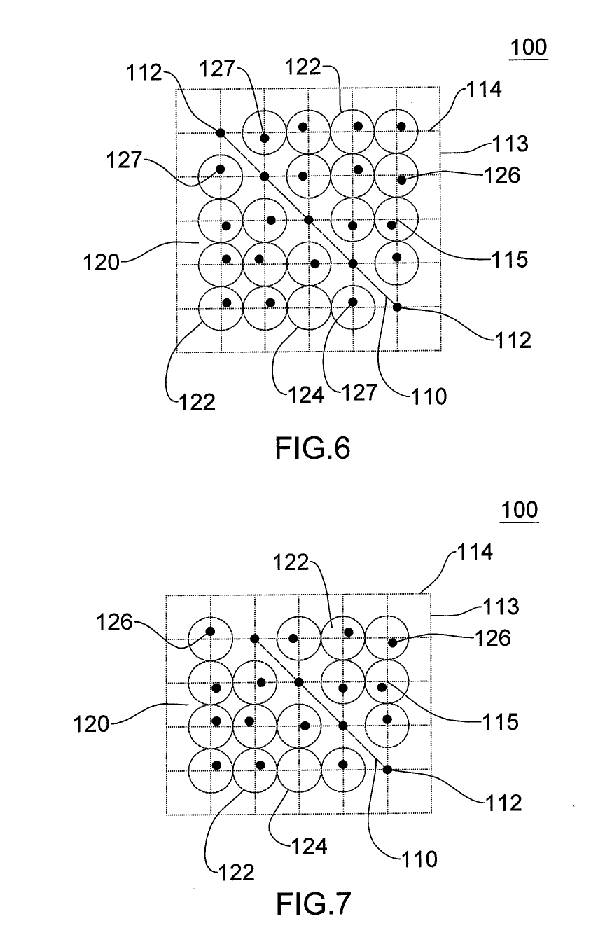

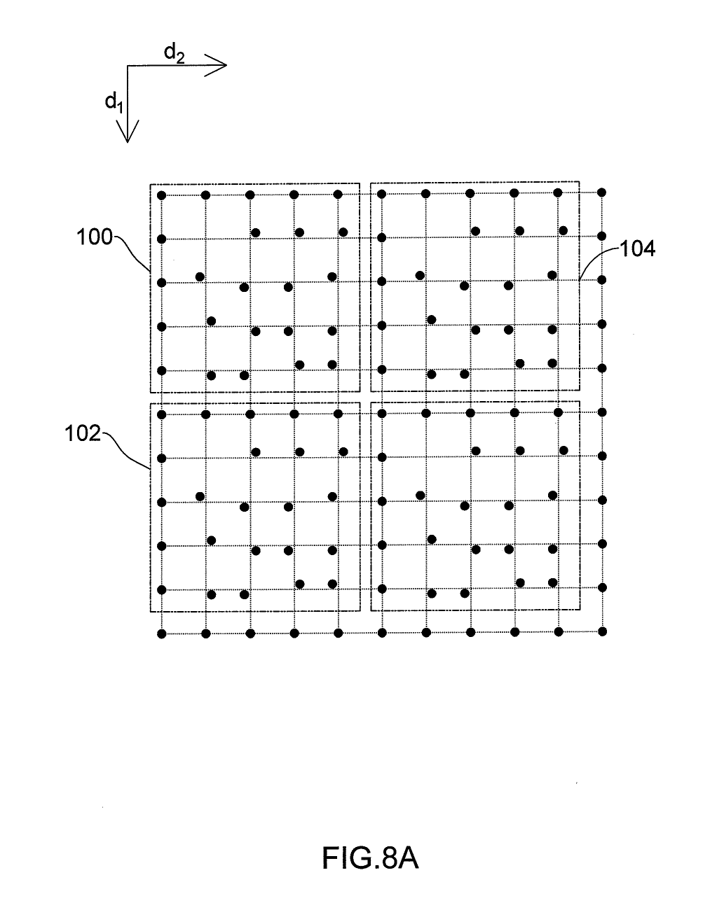

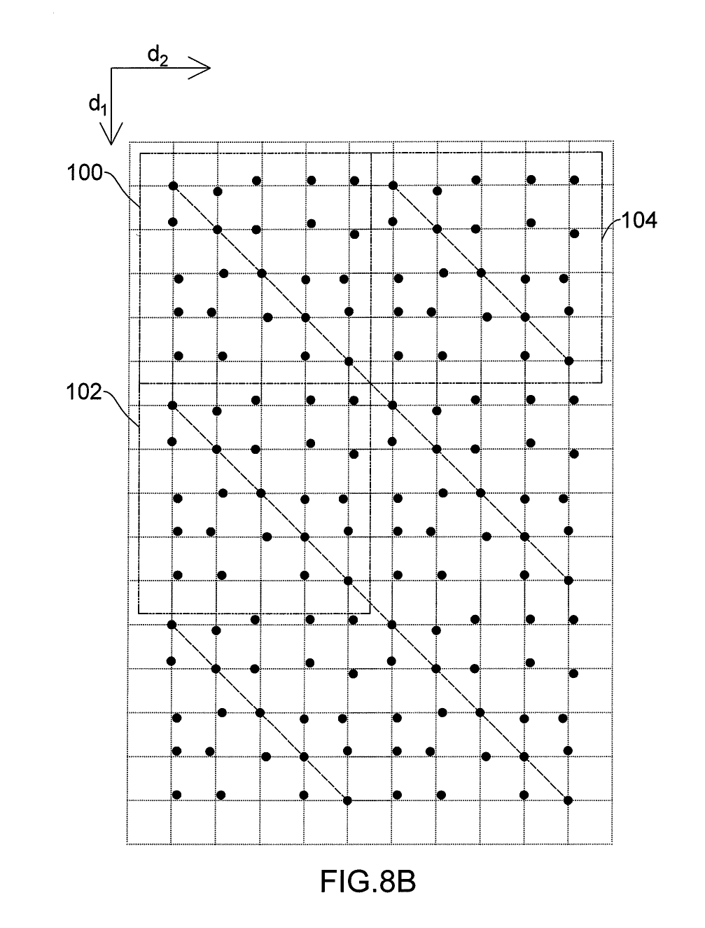

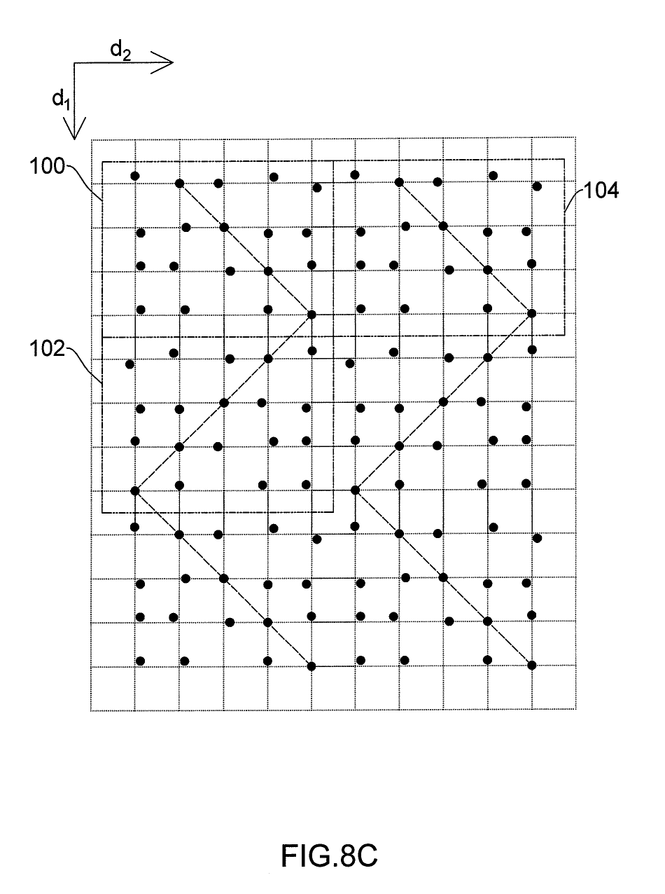

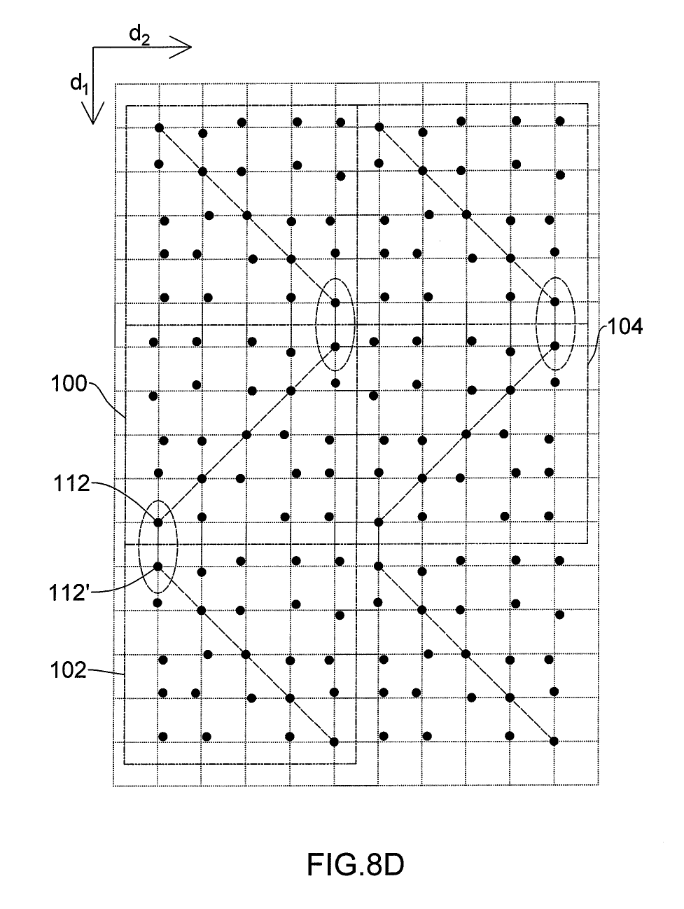

In the foregoing embodiments, there may be a plurality of dot pattern units arranged in matrix as illustrated in FIG. 8A, FIG. 8B, FIG. 8C and FIG. 8D. Referring first to FIG. 8A and FIG. 8B, FIG. 8A is formed by the pattern units shown in FIG. 1C arranged in matrix, and the unit recognition portion of each pattern unit 100, 102, 104 is located on the periphery of the pattern unit 100, 102, 104; FIG. 8B is formed by the pattern units shown in FIG. 6 arranged in matrix, and the unit recognition portion of each pattern unit 100, 102, 104 is located on the diagonal line of the pattern unit 100, 102, 104, wherein the pattern units in FIG. 8A and FIG. 8B along a first direction d₁ and second direction d₂ are all with the same orientations. Referring next to FIG. 8C, FIG. 8C is formed by the pattern units shown in FIG. 7, the unit recognition portion of each pattern unit 100, 102, 104 is located on an oblique line having an included angle with the diagonal line of the pattern unit 100, 102, 104, and the adjacent two pattern units along the first direction d₁, such as the pattern units 100 and 102, are oriented such that their unit recognition portions are on oblique lines in different directions. FIG. 8D illustrates a configuration according to another embodiment. It is formed by the pattern units shown in FIG. 6, the unit recognition portion of each pattern unit 100, 102, 104 is located on the diagonal line of the pattern unit 100, 102, 104, and two adjacent pattern units along the first direction d₁, such as the pattern units 100 and 102, are oriented such that their unit recognition portions are located on diagonal lines in different directions. Moreover, in the two adjacent pattern units 100 and 102 along the first direction d₁, two adjacent first dot patterns 112, 112′ are co-linear along the first direction d₁. A similar configuration may also be formed in the two adjacent pattern units 100 and 104 along the second direction d₂ and the description therefor is omitted here. Configurations shown in FIG. 8C and FIG. 8D are not only artistic but also more convenient to decode because the configurations of the unit recognition portions have strong characteristics, and different pattern units may be distinguished by a turn of the unit recognition portions.

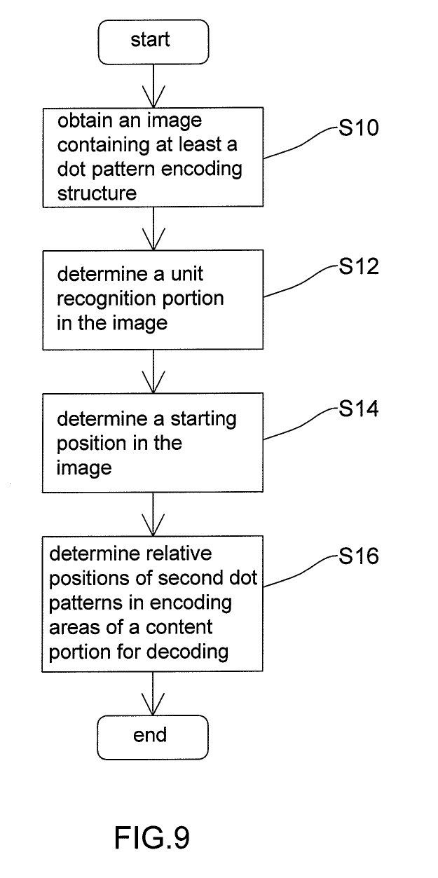

FIG. 9 is a flow chart of the decoding method for the dot pattern encoding structure according to an embodiment. As illustrated in the figure, the decoding method for the dot pattern encoding structure includes the following steps. First, an image containing at least a dot pattern encoding structure is obtained (step S10). The dot pattern encoding structure may include any of the aforementioned encoding structures, and the description therefor is omitted here. Next, a unit recognition portion is determined from the image (step S12). Thereafter, a starting position is determined from the image (step S14); and relative positions of the second dot patterns in the encoding areas of a content portion are determined for decoding (step S16). The following is a detailed description of the above steps.

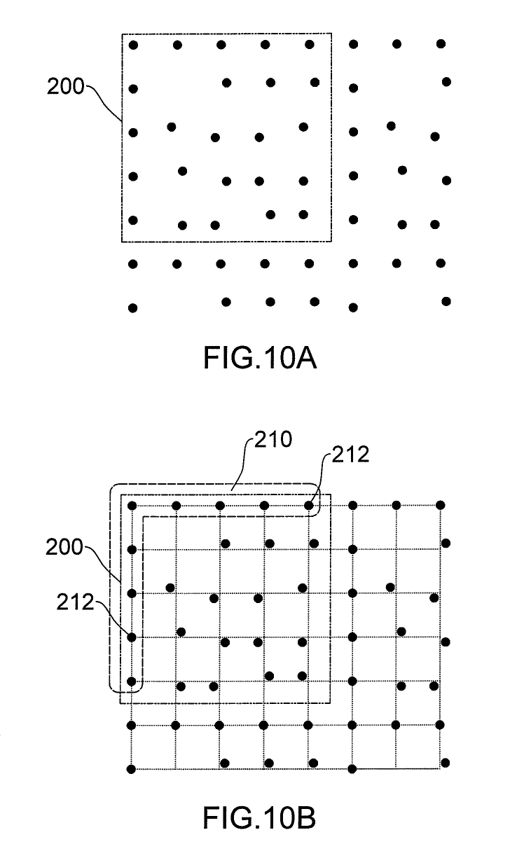

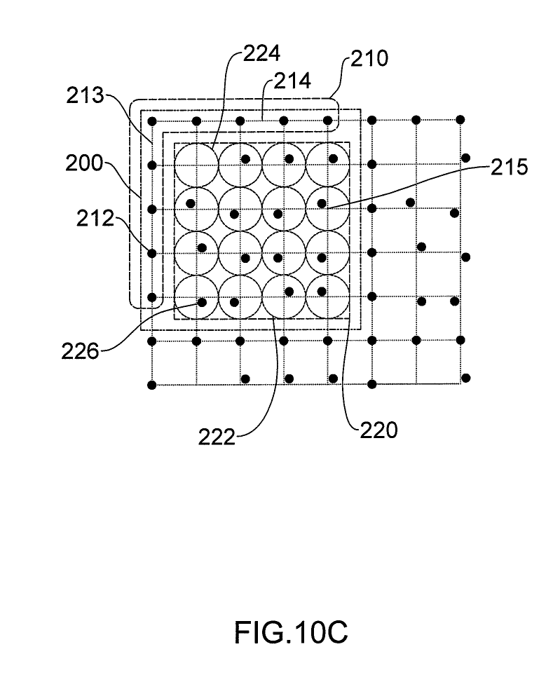

In the step S10, the image obtained may include a complete pattern unit or a plurality of partial pattern units as shown in FIG. 10A. A complete pattern unit 200 is shown for example. Next, in the step S12, the unit recognition portion is determined from the complete or partial pattern units in the image by a method including the following steps. Referring to FIG. 10B, dot patterns that are co-linear and equally distanced are identified, and these dot patterns are defined to be the first dot patterns 212, and the locations of these first dot patterns 212 constitute the unit recognition portion 210 for the recognition of a single pattern unit 200. Next, referring to FIG. 10C, virtual coordinates are constructed by a plurality of virtual grid lines 213, 214 passing through the aforementioned first dot patterns 212. A plurality of encoding areas 222 are formed by crossing the virtual grid lines 213, 214. An intersecting point of the virtual grid lines 213, 214 is defined to be a virtual intersecting point 215; and a dot pattern adjacent to the virtual intersecting point 215 and not within the unit recognition portion 210 is defined to be a second dot pattern 226. Locations of these second dot patterns constitute the content portion 220. Thereafter, referring to FIG. 10C, in the step S14, an area in the content portion 220 that is blank or containing at least two dot patterns 226 is determined as the starting position 224 of the decoding directions of the content portion 220. Different encoding directions are represented by the positions of the second dot pattern 226 in the four quadrants. Lastly, after the unit recognition portion 210 and the starting position 224 of the content portion 220 are determined, decoding may be performed according to the relative positions of the second dot patterns 226 in the encoding areas 222 in the content portion 220.

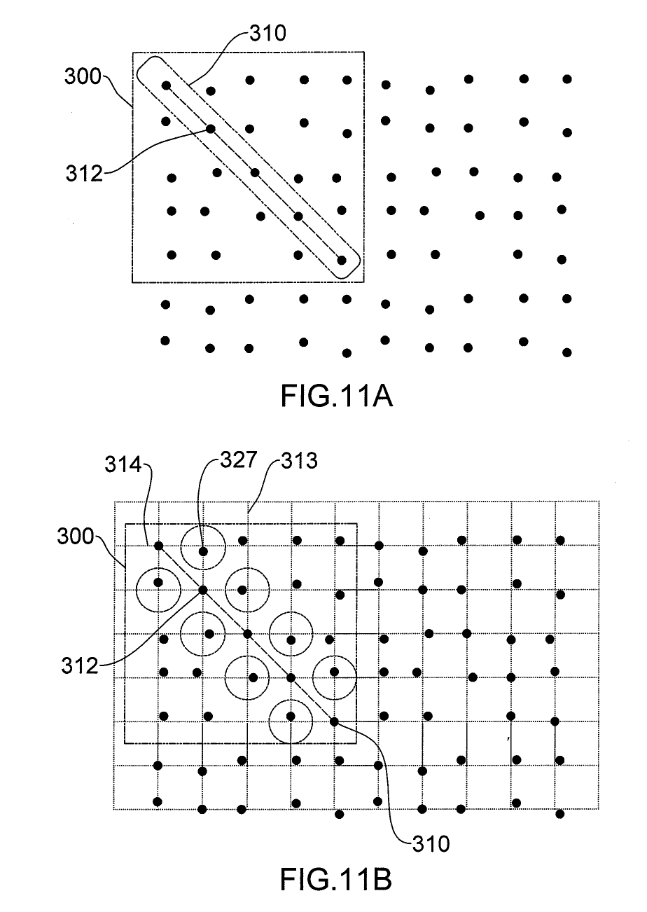

According to an embodiment, when an image to be decoded is known to be the one shown in FIG. 11A, where a unit recognition portion 310 is located on a diagonal line of a pattern unit 300, then after the unit recognition portion 310 is determined by the equally distanced and co-linear principle, virtual coordinates may be generated by defining virtual grid lines 313, 314 crossing each other by rotating the identified diagonal line by 45°, as illustrated in FIG. 11B. In the case at least one of the second patterns 327 are co-linear with the adjacent known first dot pattern 312, then the virtual coordinate plane formed by 45° rotation may be calibrated by an actual vector. In such way, decoding would be more accurate.

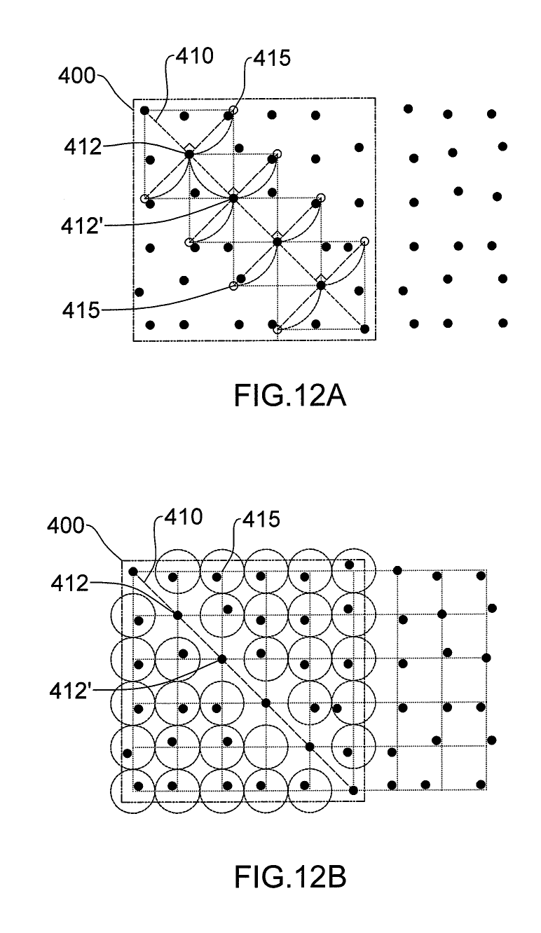

According to still another embodiment, when an image to be decoded is known to be the one shown in FIG. 12A and FIG. 12B, where a unit recognition portion 410 is located on a diagonal line of a pattern unit 400 or an oblique line having an included angle with a diagonal line of a pattern unit 400. After the unit recognition portion 410 is determined by applying the equally distanced and co-linear principle, a virtual intersecting point 415 may be determined by rotating a first dot pattern 412 with respect to another first dot pattern 412′ by 90°. In such way, estimated intersecting points may be reduced, and a more accurate virtual coordinate plane may be obtained.

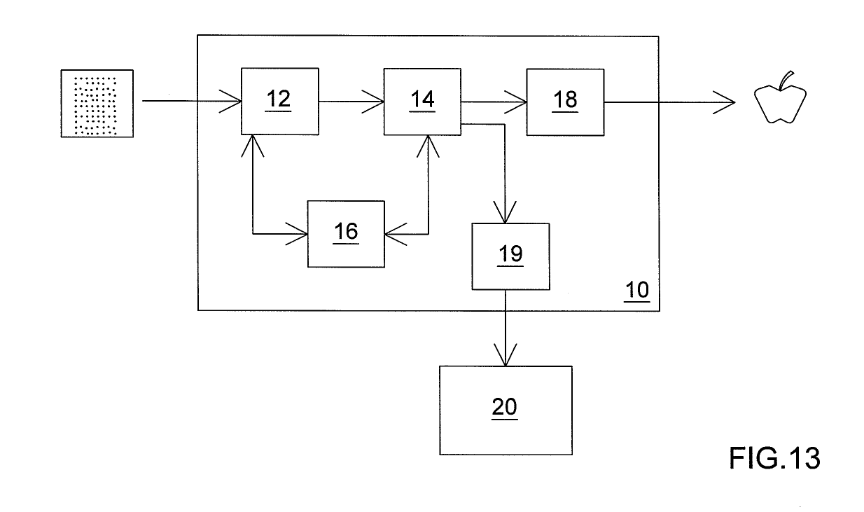

Referring to FIG. 13, according to another embodiment, an electronic device 10 for decoding any of the dot pattern encoding structures according to the above embodiments includes a pattern sensing unit 12 for obtaining an image including the aforementioned dot pattern encoding structure; and a decoding processing unit 14 employing the encoding method in the foregoing embodiment to identify the unit recognition portion, the starting position and the relative positions of the second dot patterns in the encoding areas for decoding. According to an embodiment, the electronic device 10 further includes a storage unit 16 for storing the references required by the decoding unit.

According to yet another embodiment, the electronic device 10 further includes an output unit 18 for outputting the decoded result by means of sound or image. Moreover, the electronic device 10 may further includes a communication interface 19 for transmitting the decoded result, wherein the communication interface include wired communication interface and/or wireless communication interface, such as a USB interface, Bluetooth interface, which can transmit the decoded result to another device 20 that allows a user to store or use the decoded result.

According to the foregoing description, a characteristic of the present invention is that a unit recognition portion for recognition of a single pattern unit may be disposed on the periphery, the diagonal line or an oblique line having an included angle with the diagonal line of the pattern unit. Such configurations are not only more visually pleasing, but also have good decoding effects because the unit recognition portions are characteristically stronger. Besides, when the unit recognition portions are disposed on the diagonal line of the pattern unit, there would be more available encoding areas for encoding.

In summary, the dot pattern encoding structure, its decoding method and electronic device of the present invention not only has more visually pleasing encoding structure, but also has more accurate decoding effects.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An dot pattern encoding structure comprising:
at least a pattern unit comprising:
a unit recognition portion containing a plurality of first dot patterns part or all of which are co-linear and equally distanced; and a plurality of first virtual grid lines and a plurality of second virtual grid lines passing through the first dot patterns, wherein the first virtual grid lines and the second virtual grid lines cross with each other and form a plurality of virtual intersecting points; and
a content portion containing a plurality of encoding areas and a starting position formed by crossing of the first virtual grid lines and second virtual grid lines, wherein each of the encoding areas contains a second dot pattern disposed in one of four quadrants, or on the first virtual grid line or the second virtual grid line, and a pattern configuration at the starting position is different from that in any of the encoding areas.

2. The dot pattern encoding structure according to claim 1, wherein the unit recognition portion is located on a periphery, a diagonal line or an oblique line having an included angle with a diagonal line of the pattern unit.

3. The dot pattern encoding structure according to claim 1, wherein the unit recognition portion is located on a diagonal line of the pattern unit, and the second dot patterns adjacent to the first dot patterns are located on the first virtual grid lines or the second virtual grid lines.

4. The dot pattern encoding structure according to claim 1, wherein the virtual intersecting points at the four corners of the pattern unit are blank.

5. The dot pattern encoding structure according to claim 4, wherein the starting position contains two second dot patterns, respectively located on the first virtual grid line and the second virtual grid line, and the virtual intersecting points adjacent to the second dot patterns in the starting position are blank.

6. The dot pattern encoding structure according to claim 1, wherein the starting position is blank or contains at least two second dot patterns disposed on the first virtual grid line, the second virtual grid line or the four quadrants.

7. The dot pattern encoding structure according to claim 1, wherein the number of pattern units is plural and the plurality of pattern units are arranged in matrix.

8. The dot pattern encoding structure according to claim 7, wherein the unit recognition portion is located on the diagonal line of the pattern unit, and the unit recognition portions of adjacent two of the pattern units along a first direction or a second direction are located on the diagonal lines in different or the same directions, and the two adjacent first dot patterns in the two adjacent pattern units along the first direction or the second direction are co-linear along the first direction or the second direction.

9. The dot pattern encoding structure according to claim 7, wherein the unit recognition portion is located on an oblique line having an included angle with a diagonal line of the pattern unit, and the unit recognition portions of adjacent two of the pattern units along a first direction or a second direction are located on the oblique lines with different directions.

10. A decoding method for a dot pattern encoding structure comprising the following steps:
obtaining an image containing at least a dot pattern encoding structure, the dot pattern encoding structure comprising:
at least a pattern unit consisting of a single pattern unit or a plurality of partial pattern units, the pattern unit comprising:
a unit recognition portion containing a plurality of first dot patterns part or all of which are co-linear and equally distanced; and a plurality of first virtual grid lines and a plurality of second virtual grid lines passing through the first dot patterns, wherein the first virtual grid lines and the second virtual grid lines cross with each other and form a plurality of virtual intersecting points; and
a content portion containing a plurality of encoding areas and a starting position formed by crossing of the first virtual grid lines and second virtual grid lines, wherein each of the encoding areas contains a second dot pattern disposed in one of four quadrants, or on the first virtual grid line or the second virtual grid line, and a pattern configuration at the starting position is different from that in any of the encoding areas;
determining the unit recognition portion in the image;
determining the starting position in the image; and
determining relative positions of the second dot patterns in the encoding areas in the content portion for decoding.

11. The decoding method for the dot pattern encoding structure according to claim 10, wherein the step of determining the unit recognition portion comprises determining the first dot patterns part or all of which are co-linear and equally distanced from the image, and determining the virtual intersecting points from the first dot patterns.

12. The decoding method for the dot pattern encoding structure according to claim 10, wherein the step of determining the starting position involves identifying an area that is blank or contains at least two second dot patterns from the content portion.

13. The decoding method for the dot pattern encoding structure according to claim 10, wherein the step of determining the relative position of the second dot pattern in the encoding area is based on the position of the second dot pattern in the four quadrants of the encoding area.

14. The decoding method for the dot pattern encoding structure according to claim 10, wherein the unit recognition portion is located on a periphery, a diagonal line or an oblique line having an included angle with a diagonal line of the pattern unit.

15. The decoding method for the dot pattern encoding structure according to claim 10, wherein the unit recognition portion is located on a diagonal line of the pattern unit, and the second dot patterns adjacent to the first dot patterns are located on the first virtual grid lines or the second virtual grid lines.

16. The decoding method for the dot pattern encoding structure according to claim 10, wherein the virtual intersecting points at the four corners of the pattern unit are blank.

17. The decoding method for the dot pattern encoding structure according to claim 16, wherein the starting position contains two second dot patterns, respectively located on the first virtual grid line and the second virtual grid line, and the virtual intersecting points adjacent to the second dot patterns in the starting position are blank.

18. The decoding method for the dot pattern encoding structure according to claim 10, wherein the starting position is blank or contains at least two second dot patterns disposed on the first virtual grid line, the second virtual grid line or the four quadrants.

19. The decoding method for the dot pattern encoding structure according to claim 10, wherein the number of pattern units is plural and the plurality of pattern units are arranged in matrix.

20. The decoding method for the dot pattern encoding structure according to claim 19, wherein the unit recognition portion is located on the diagonal line of the pattern unit, and the unit recognition portions of adjacent two of the pattern units along a first direction or a second direction are located on the diagonal lines in different or the same directions, and the two adjacent first dot patterns in the two adjacent pattern units along the first direction or the second direction are co-linear along the first direction or the second direction.

21. The decoding method for the dot pattern encoding structure according to claim 19, wherein the unit recognition portion is located on an oblique line having an included angle with a diagonal line of the pattern unit, and the unit recognition portions of adjacent two of the pattern units along a first direction or a second direction are located on the oblique lines with different directions.

22. An electronic device for decoding a dot pattern encoding structure, the electronic device comprising:
an image sensing unit for obtaining an image, the image comprising the dot pattern encoding structure, wherein the dot pattern encoding structure comprises:
at least a pattern unit comprising:
a unit recognition portion containing a plurality of first dot patterns part or all of which are co-linear and equally distanced; and a plurality of first virtual grid lines and a plurality of second virtual grid lines passing through the first dot patterns, wherein the first virtual grid lines and the second virtual grid lines cross with each other and form a plurality of virtual intersecting points; and
a content portion containing a plurality of encoding areas and a starting position formed by crossing of the first virtual grid lines and second virtual grid lines, wherein each of the encoding areas contains a second dot pattern disposed in one of four quadrants, or on the first virtual grid line or the second virtual grid line, and a pattern configuration at the starting position is different from that in any of the encoding areas;
a decoding processing unit for determining the unit recognition portion, the starting position and relative positions of the second dot patterns in the encoding areas in the content portion for decoding.

23. The electronic device according to claim 22, further comprising an output unit for outputting a decoded result by means of sound or image.

24. The electronic device according to claim 22, further comprising a communication interface for transmitting a decoded result.

25. The electronic device according to claim 24, wherein the communication interface is wired or wireless.

26. The electronic device according to claim 22, wherein the step of determining the unit recognition portion by the encoding processing unit comprises determining the first dot patterns part or all of which are co-linear and equally distanced from the image, and forming the virtual grid lines by extending from the first dot patterns.

27. The electronic device according to claim 22, wherein the step of determining the starting position by the decoding processing unit involves identifying an area that is blank or contains at least two second dot patterns from the content portion.

28. The electronic device according to claim 22, wherein the step of determining the relative position of the second dot pattern in the encoding area by the decoding processing unit is based on the position of the second dot pattern in the four quadrants of the encoding area.

29. The electronic device according to claim 22, wherein the unit recognition portion is located on a periphery, a diagonal line or an oblique line having an included angle with a diagonal line of the pattern unit.

30. The electronic device according to claim 22, wherein the unit recognition portion is located on a diagonal line of each pattern unit, and the second dot patterns adjacent to the first dot patterns are located on the first virtual grid lines or the second virtual grid lines.

31. The electronic device according to claim 22, wherein the virtual intersecting points at the four corners of the pattern unit are blank.

32. The electronic device according to claim 31, wherein the starting position contains two second dot patterns, respectively located on the first virtual grid line and the second virtual grid line, and the virtual intersecting points adjacent to the second dot patterns in the starting position are blank.

33. The electronic device according to claim 22, wherein the starting position is blank or contains at least two second dot patterns disposed on the first virtual grid line, the second virtual grid line or the four quadrants.

34. The electronic device according to claim 22, wherein the number of pattern units is plural and the plurality of pattern units are arranged in matrix.

35. The electronic device according to claim 34, wherein the unit recognition portion is located on the diagonal line of the pattern unit, and the unit recognition portions of adjacent two of the pattern units along a first direction or a second direction are located on the diagonal lines in different or the same directions, and the two adjacent first dot patterns in the two adjacent pattern units along the first direction or the second direction are co-linear along the first direction or the second direction.

36. The electronic device according to claim 34, wherein the unit recognition portion is located on an oblique line having an included angle with a diagonal line of the pattern unit, and the unit recognition portions of adjacent two of the pattern units along a first direction or a second direction are located on the oblique lines with different directions.

37. The electronic device according to claim 22, further comprising a storage unit for storing the references required by the decoding processing unit.
